(19) United States
(12) Patent Application Publication
(10) Pub. No.: US 2012/0104773 A1
(43) Pub. Date: May 3, 2012

(54) BAND FOR ELECTROMAGNETIC SUCTION CUPS

(75) Inventor: Jacob Benhammou, La Queue en Brie (FR)

(73) Assignee: DIGIT Société par actions simplifée, Pantin (FR)

(21) Appl. No.: 13/383,750

(22) PCT Filed: Mar. 26, 2010
(86) PCT No.: PCT/FR2010/000253

§ 371 Date: Jan. 12, 2012

(30) Foreign Application Priority Data
Jul. 22, 2009 (FR) 09 03610

(51) Int. Cl. E05C 19/16

(52) U.S. Cl. 292/251.5

(57) ABSTRACT

The invention relates to a band for electromagnetic suction cups, comprising a tubular profile section (2) having two wings (3-4), one of which is provided with an auxiliary attachment wing (6) extending parallel to the lower surface (5) of the profile section, the opposite surface (12) of which has a second auxiliary wing (13), which forms a handle and which extends above the attachment wing (6) which has a semicircular groove (7) with a swaged opening into which the edge of a screw cover can be slidingly inserted, wherein the other edge of the screw cover comprises a groove, the profile of which enables the same to engage with a rim (11) of the band by snap-fitting, characterized in that the free edge of the handle (13) has a rim (14) similar to the above-mentioned one (11).

The present invention relates to improvements to the bands to enable the use of electric locks known as “electromagnetic suction cups.”

A suction cup comprises two portions, the cup itself, comprised of a prism-shaped electromagnet, and a metallic plywood made of soft iron.

The band, attached to the movable portion of the opening to be closed, namely the door, serves to support the plywood, conceals the suction cup, and comprises gripping means, namely a handle, for operating said door.

The band comes in the form of a tubular profile section, whose surface receiving the plywood comprises two wings forming, with said surface, a U-shaped groove in which the suction cup is housed.

One of the aforementioned wings has, at its free end, an auxiliary wing that extends parallel to the surface comprising the plywood. This auxiliary wing is used to fix the band against the door.

The surface of the tubular profile section, opposite that receiving the plywood, extends beyond the profile section and on the same side as the aforementioned auxiliary wing, along a second auxiliary wing forming the handle.

When the band is set, the attachment screws are hidden under a “screw cover” in the form of a rod that is snap-fitted on the band.

To this end, the end of the auxiliary wing has a semicircular groove with a swaged opening into which one of the longitudinal edges of the screw cover, which has a rim with a circular cross-section, is slidably engaged.

The other longitudinal edge of the screw cover has a groove, the cross-section of which is appropriately determined to cooperate, by snap-fitting, with a rim of the outer surface of the tubular profile section forming the band.

The band generally extends over the entire height of the door, and therefore, the handle extends over the same height. This arrangement enables a plurality of people to grab the handle and to exert on the door a force that is far greater than that developed by the suction cup.

Certain users want the suction cup to be arranged at the upper portion of the door. Under these conditions, the aforementioned band is arranged horizontally, the auxiliary wing forming the handle is then completely unnecessary, and its presence negatively affects the aesthetic appearance.

The band of the invention, which overcomes these disadvantages, is characterized in that the free edge of the wing forming the handle has a rim, similar to that known, that enables snap-fitting of the screw cover.

This arrangement particularly makes it possible to eliminate the presence of the handle when the band is arranged horizontally, and the same band can therefore be used both in a vertical position and in a horizontal position.

According to another characteristic of the invention, the distances separating the two rims and the swaged semi-circular groove are equal, and the profiles of the two rims are identical.

This arrangement makes it possible to use the same screw cover for two different uses of the band.

Other characteristics will become more apparent from the following description, with reference to the annexed drawings provided by way of example only, and in which:

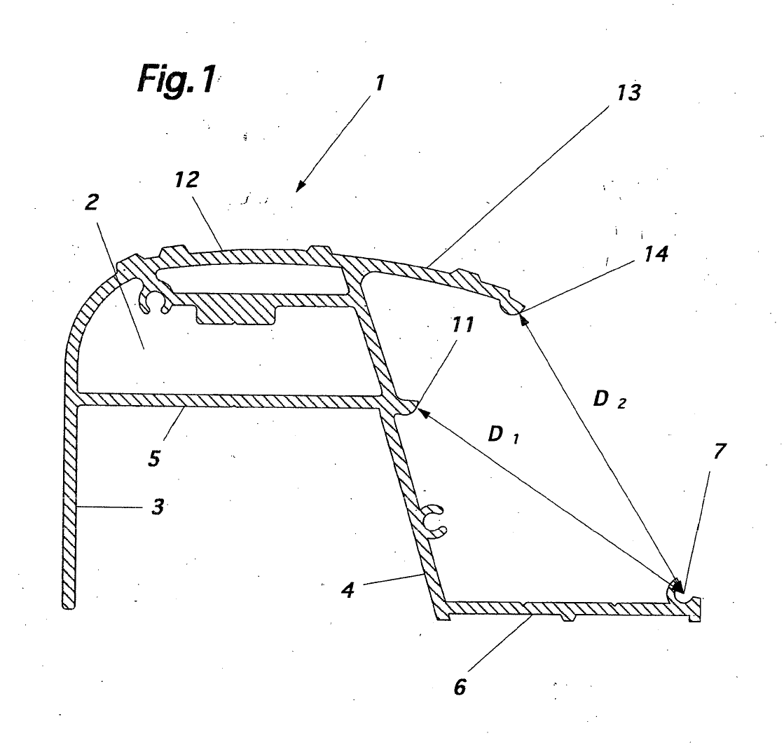

FIG. 1 is a transverse cross-sectional view of a band according to the invention;

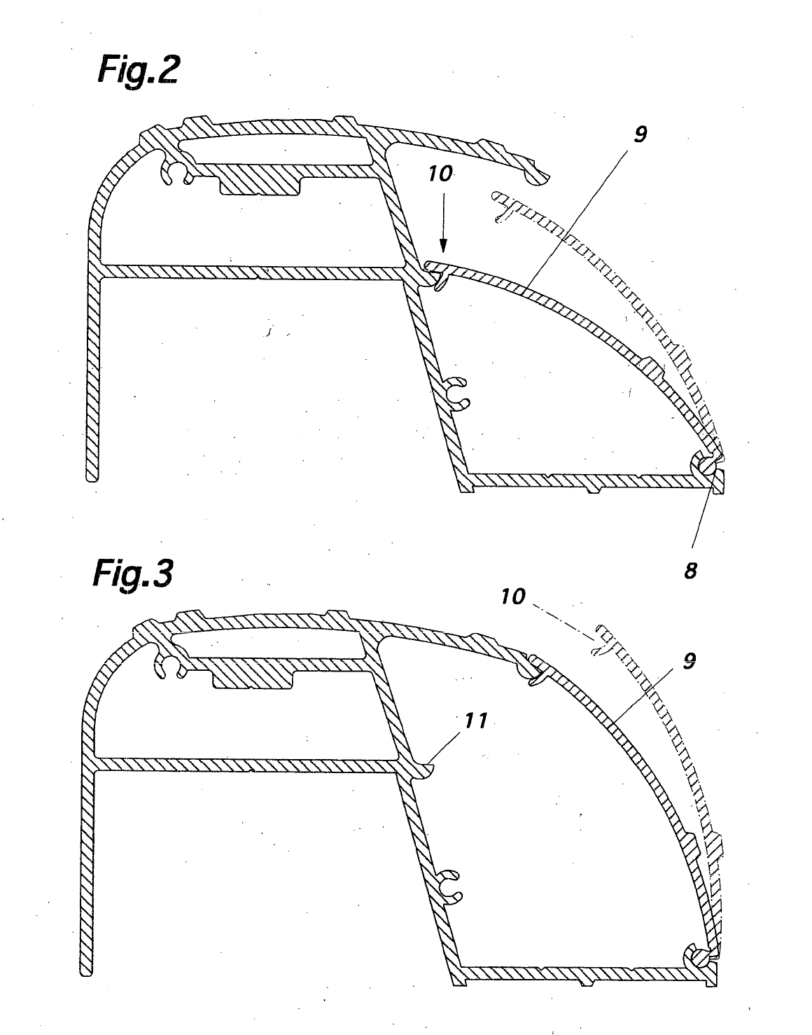

FIGS. 2 and 3 are views similar to FIG. 1, showing the two possible positions of the screw cover;

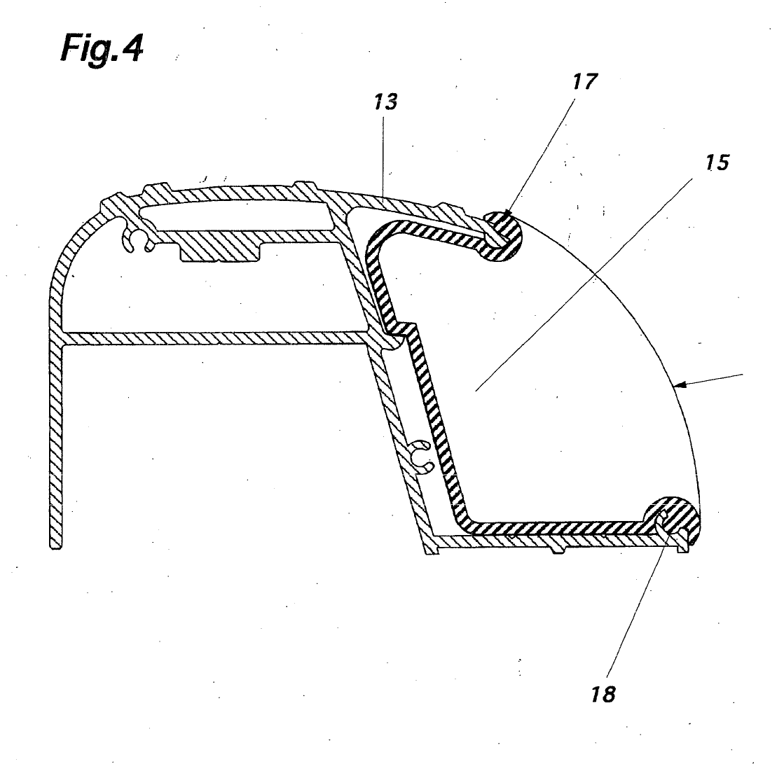

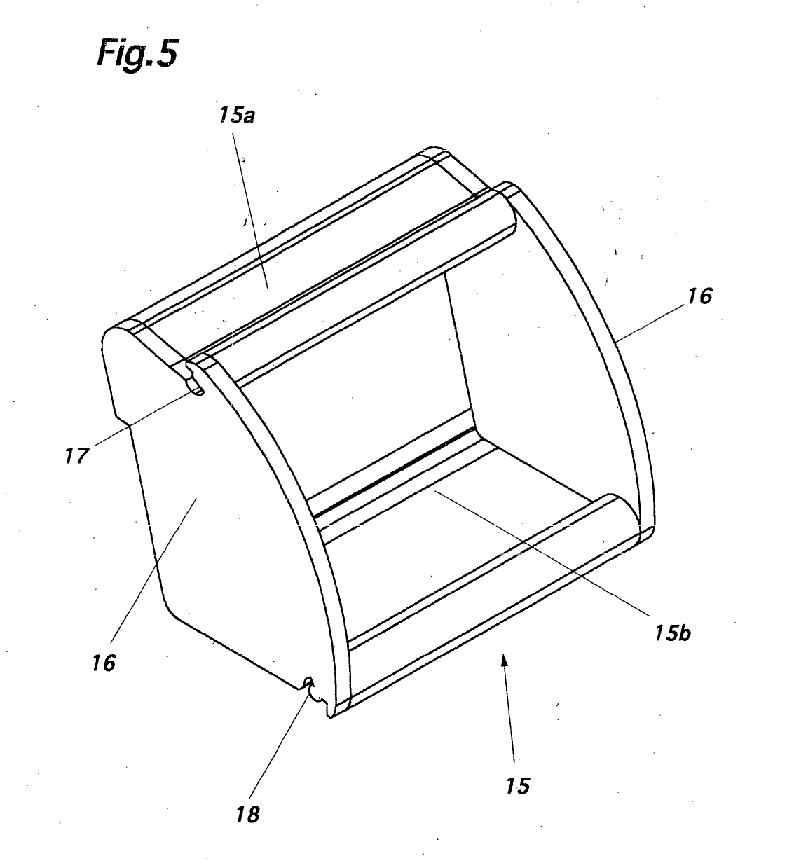

FIG. 4 is a transverse cross-sectional view of the band of the invention, showing the possibility of using a smaller grip handle;

FIG. 5 is a perspective view of the handle of FIG. 5;

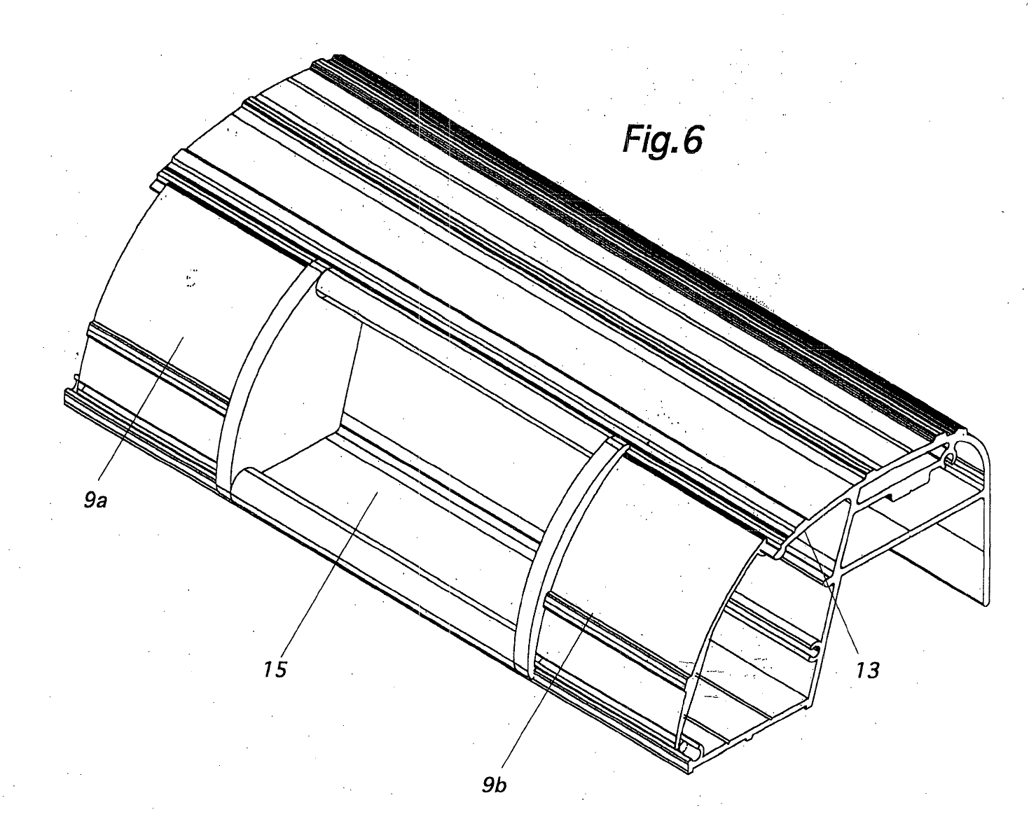

FIG. 6 is a perspective view showing a band equipped with a smaller grip handle.

Referring to the drawings, one can see that the band 1 is conventionally comprised of a tubular profile section 2 having two wings 3 and 4 forming, with the surface 5 of the profile section, a groove that conceals the suction cup (not shown) when the door is closed. This arrangement is described in the European Patent No. 1563151.

The free end of the wing 4 has an auxiliary wing 6, extending parallel to the surface 5 and making it possible to fix the band using screws (not shown).

In a known fashion, the free end of the wing 6 has a semicircular groove 7 with a swaged opening into which a rim 8 with circular cross-section of the usual screw cover 9 is engaged by longitudinal sliding. When sliding, the screw cover is arranged as shown in dot and dash lines in FIG. 2.

The edge of the screw cover 9, opposite the rim 8, has a groove 10, the cross-section of which is appropriately determined to cooperate, by snap-fitting, with a rim 11 extending outward of the profile section 2 and arranged, for example, substantially in the area of the surface 5.

The surface 12 of the profile section 2, opposite the surface 5, extends into a second auxiliary wing 13, extending above the wing 6 and forming a longitudinal handle.

According to the invention, the free end of the handle 13 comprises a rim 14 similar, if not identical, to the rim 11.

This arrangement has the advantage of eliminating the presence of the handle 13 when the band is arranged in a horizontal position (FIG. 3), but also in a vertical position, under certain conditions, as will be described hereinafter.

According to another characteristic of the invention, the distances D1 and D2 separating the rim 11 and the groove 7, on the one hand, and the upper rim 14 and the aforementioned groove 7, on the other hand, are equal.

This arrangement makes it possible to use the same screw cover, whether the band is mounted vertically or horizontally.

A means for preventing the door from being operated by a plurality of people will now be described. To achieve this goal, an auxiliary reduced grip handle 15 is used.

The handle 15 is comprised of a substantially U-shaped profile section, the ends of which are closed by the flanges 16. This auxiliary handle 15 is preferably positioned by longitudinal sliding, and is held between the wings 6 and 13.

The upper arm 15a has a groove 17, the cross-section of which reproduces the profile of the rim 14, whereas the lower arm 15b has a circular rim 18 identical to that 8 of the screw cover.

As shown in FIG. 6, the handle 15 is longitudinally immobilized by two screw cover portions 9a and 9b.

The two sections 9a and 9b, engaged with the rim 14, prevent the visitors from reaching the handle 13 for an ill-timed opening of the door.

It should be noted that the means described hereinabove do not prevent the band from being used in the known fashion (FIG. 2).

1. Band for electromagnetic suction cups comprising a tubular profile section (2) having two wings (3-4), one of which is provided with an auxiliary attachment wing (6) extending parallel to the lower surface (5) of the profile section, the opposite surface (12) of which has a second auxiliary wing (13), forming a handle and extending above the attachment wing (6), which has a semicircular groove (7) with a swaged opening into which one edge of a screw cover (9) can be slidably engaged, and the other edge of the screw cover comprises a groove, the profile of which enables cooperation with a rim (11) of the band by snap-fitting, characterized in that the free edge of the handle (13) has a rim (14) similar to that (11) mentioned hereinabove.

2. Band according to claim 1, characterized in that the snap-fitting rims (11 and 14) are identical.

3. Band according to claims 1, characterized in that the distances (D1 and D2) separating the first rim and the semi-circular groove, on the one hand, and the second rim and said groove, on the other hand, are equal.

4. Band according to claim 1, characterized in that in order to limit the length of the gripping zone of the band, an auxiliary handle comprised of a substantially U-shaped profile section is used, the ends of which are closed by flanges (16), said handle being capable of being engaged by longitudinal sliding between the first auxiliary wing and the second auxiliary wing, and of being maintained therebetween.

5. Band according to claim 4, characterized in that the auxiliary handle has a groove (17), the profile of which conforms to that of the upper rim (14), and a circular rim (18) identical to that (8) of the screw cover (9).
